(19) United States
(12) Patent Application Publication
(10) Pub. No.: US 2025/0377222 A1
(43) Pub. Date: Dec. 11, 2025

(54) ANGLE DETECTION DEVICE AND ANGLE DETECTION METHOD

(71) Applicant: NIDEC CORPORATION, Kyoto (JP)

(72) Inventor: Shota ISHIGAMI, Kyoto (JP)

(21) Appl. No.: 18/875,168

(22) PCT Filed: May 26, 2023
(86) PCT No.: PCT/JP2023/019720

§ 371 Date: Dec. 16, 2024

(30) Foreign Application Priority Data
Jun. 30, 2022 (JP) 2022-106311

(51) Int. Cl. G01D 5/14

(52) U.S. Cl. CPC G01D 5/145

(57) ABSTRACT

An angle detection device includes a sensor magnet on a shaft of an N-phase motor having a rotor magnet, M magnetic sensors detecting a magnetic flux change due to rotation of the sensor magnet, a storage device storing an expression representing a relationship between an output value of the M magnetic sensors and a mechanical angle of the shaft corresponding to a rotational position of the rotor magnet as a level switching angle, and a processing device calculating the mechanical angle based on the output value and the expression, and outputting an N-phase pulse signal having a phase difference of 360 degrees divided by N in terms of electrical angle based on the calculated mechanical angle and the level switching angle. The processing device switches a level of a pulse signal of any one phase of the N-phase pulse signal when the calculated mechanical angle matches the level switching angle.

### CROSS-REFERENCE TO RELATED APPLICATIONS

This is the U.S. national stage of application No. PCT/JP2023/019720, filed on May 26, 2023, and priority under 35 U.S.C. § 119 (a) and 35 U.S.C. § 365 (b) is claimed from Japanese Patent Application No. 2022-106311, filed on Jun. 30, 2022.

### TECHNICAL FIELD

The present invention relates to an angle detection device and an angle detection method.

### BACKGROUND ART

Conventionally, as a device for detecting a rotational position (mechanical angle) of a motor, an incremental encoder that outputs an A-phase pulse signal, a B-phase pulse signal, and a Z-phase pulse signal has been known. In an encoder in this system, an A-phase pulse signal and a B-phase pulse signal start to be output quickly after power is turned on, but a Z-phase pulse signal is sometimes output later.

For this reason, a host device that receives each pulse signal from the encoder can acquire only a relative angle based on an A-phase pulse signal and a B-phase pulse signal until a Z-phase pulse signal is output from the encoder, which may cause inconvenience depending on the specifications of an application.

In view of the above, an encoder that outputs a U-phase pulse signal, a V-phase pulse signal, and a W-phase pulse signal based on output signals of three position sensors incorporated in a motor so that a host device can acquire an absolute angle in a period until a Z-phase pulse signal is output from the encoder is known. Generally, the three position sensors incorporated in a motor are magnetic sensors that detect a magnetic flux change due to rotation of a rotor magnet of the motor.

For example, output signals (analog signals) of the three position sensors are referred to as a U-phase sensor signal, a V-phase sensor signal, and a W-phase sensor signal. In this case, the U-phase pulse signal is a digital signal that becomes a high level when a U-phase sensor signal is higher than reference potential (for example, 0 V) and becomes a low level when the U-phase pulse signal is lower than the reference potential. The V-phase pulse signal is a digital signal that becomes a high level when a V-phase sensor signal is higher than the reference potential and becomes a low level when the V-phase pulse signal is lower than the reference potential. The W-phase pulse signal is a digital signal that becomes a high level when a W-phase sensor signal is higher than the reference potential and becomes a low level when the W-phase pulse signal is lower than the reference potential.

Conventionally, a configuration including an absolute angle position sensor such as an optical encoder and a resolver is known as a motor capable of accurately controlling a rotational position. However, the absolute angle position sensor is large in size and high in cost. In view of the above, Patent Literature 1 discloses a position estimation method of estimating a rotational position (mechanical angle) of a motor by using three inexpensive and small magnetic sensors without using an absolute angle position sensor.

### CITATIONS LIST

### Patent Literature

Patent Literature 1: JP 6233532 B2

### SUMMARY OF INVENTION

### Technical Problems

The present applicant has developed a new incremental encoder that outputs an A-phase pulse signal, a B-phase pulse signal, and a Z-phase pulse signal based on a mechanical angle obtained by the position estimation method of Patent Literature 1, but it is further required to add a function of outputting a U-phase pulse signal, a V-phase pulse signal, and a W-phase pulse signal to the new encoder.

For example, in a case where the new encoder has a configuration of estimating a mechanical angle by using output signals of three position sensors (magnetic sensors) incorporated in a motor, it is relatively easy to add a function of outputting a U-phase pulse signal, a V-phase pulse signal, and a W-phase pulse signal. This is because in this case, it is only necessary to digitally convert output signals of the three position sensors into a U-phase pulse signal, a V-phase pulse signal, and a W-phase pulse signal by using a comparator or the like.

On the other hand, for example, in a case where the motor is a sensorless motor not incorporating a position sensor, and the new encoder has a configuration of estimating a mechanical angle by using output signals of three magnetic sensors that detect a magnetic flux change due to rotation of a sensor magnet attached to a rotation shaft of the motor, a point below is considered as a technical problem.

Also in a case of estimating a mechanical angle by using output signals of three magnetic sensors that detect a magnetic flux change due to rotation of a sensor magnet, a method of digitally converting output signals of the three magnetic sensors into a U-phase pulse signal, a V-phase pulse signal, and a W-phase pulse signal by using a comparator or the like is conceivable. However, a U-phase pulse signal, a V-phase pulse signal, and a W-phase pulse signal obtained by this method are signals indicating a rotational position of the sensor magnet, and are not signals indicating a rotational position of a rotor magnet (that is, a rotational position of a rotation shaft).

For this reason, when the sensor magnet is attached to the rotation shaft of the motor, it is necessary to match the number of magnetic poles, magnetization, a zero-cross position, and the like of the sensor magnet with those of the rotor magnet. Note that the zero-cross position is a position of a boundary between an N pole and an S pole in the sensor magnet and the rotor magnet. When a boundary between an N pole and an S pole of the sensor magnet passes through a magnetic sensor, an output signal of the magnetic sensor intersects reference potential. In the present description, a phenomenon in which an output signal of a magnetic sensor intersects reference potential in this manner is referred to as “zero crossing”.

However, there may be a case where deviation occurs between a zero-cross position of the sensor magnet and a zero-cross position of the rotor magnet due to an attachment error or the like generated when the sensor magnet is attached to the rotation shaft of the motor. In this case, since a timing at which a level of a U-phase pulse signal, a V-phase pulse signal, and a W-phase pulse signal is switched deviates from an ideal timing, it is difficult to accurately indicate a rotational position (rotational position of the rotation shaft) of the rotor magnet by the U-phase pulse signal, the V-phase pulse signal, and the W-phase pulse signal.

Note that the ideal timing is a timing at which a level of a U-phase pulse signal, a V-phase pulse signal, and a W-phase pulse signal obtained from output signals of three position sensors that are incorporated in the motor and detect a magnetic flux change due to rotation of the rotor magnet is switched.

### Solutions to Problems

One aspect of an angle detection device of the present invention includes a sensor magnet mounted on a rotation shaft of an N-phase motor (N is an integer of three or more) having a rotor magnet, M (M is an integer of three or more) magnetic sensors that detect a magnetic flux change due to rotation of the sensor magnet, a storage device that stores a relational expression representing a relationship between an output value of the M magnetic sensors and a mechanical angle of the rotation shaft, and the mechanical angle corresponding to at least one rotational position of the rotor magnet as a level switching angle, and a processing device that calculates the mechanical angle based on the output value and the relational expression, and outputs an N-phase pulse signal having a phase difference of 360 degrees divided by N in terms of electrical angle based on a calculated value of the mechanical angle and the level switching angle, in which the processing device switches a level of a pulse signal of any one phase of the N-phase pulse signal when a calculated value of the mechanical angle matches with the level switching angle.

One aspect of an angle detection method of the present invention is an angle detection method of using a sensor magnet mounted on a rotation shaft of an N-phase motor (N is an integer of three or more) having a rotor magnet and M (M is an integer of three or more) magnetic sensors that detect a magnetic flux change due to rotation of the sensor magnet to detect a mechanical angle of the rotation shaft, the angle detection method including a first step of storing a relational expression representing a relationship between an output value of the M magnetic sensors and a mechanical angle of the rotation shaft, and the mechanical angle corresponding to at least one rotational position of the rotor magnet as a level switching angle, and a second step of calculating the mechanical angle based on the output value and the relational expression, and outputting an N-phase pulse signal having a phase difference of 360 degrees divided by N in terms of electrical angle based on a calculated value of the mechanical angle and the level switching angle, in which in the second step, a level of a pulse signal of any one phase of the N-phase pulse signal is switched when a calculated value of the mechanical angle matches with the level switching angle.

### Advantageous Effects of Invention

According to the above aspect of the present invention, it is possible to provide the angle detection device and the angle detection method capable of outputting an N-phase pulse signal indicating a rotational position of the rotor magnet (rotational position of the rotation shaft) with high accuracy.

### BRIEF DESCRIPTION OF DRAWINGS

FIG. 1 is a block diagram schematically illustrating a configuration of an angle detection device according to the present embodiment.

FIG. 2 is a diagram illustrating an example of waveforms of a U-phase sensor signal Hu, a V-phase sensor signal Hv, and a W-phase sensor signal Hw.

FIG. 3 is an enlarged view of the U-phase sensor signal Hu, the V-phase sensor signal Hv, and the W-phase sensor signal Hw included in one pole pair region illustrated in FIG. 2.

FIG. 4 is a flowchart illustrating an example of offline processing executed by an arithmetic device of a processing device.

FIG. 5 is a diagram illustrating an example of a relationship between a waveform of an A-phase pulse signal, a waveform of a B-phase pulse signal, a waveform of a Z-phase pulse signal, and a signal state value.

FIG. 6 is a timing chart showing a temporal correspondence relationship between an occurrence timing of an interrupt signal, a change timing of an interrupt frequency, an execution timing of interrupt processing, an operation timing of an A/D converter, and an execution timing of angle calculation processing.

FIG. 7 is a flowchart illustrating interrupt processing executed by the arithmetic device of the processing device.

FIG. 8 is an explanatory view regarding delay compensation of a mechanical angle.

FIG. 9 is a diagram illustrating an example in which an A-phase pulse signal and a B-phase pulse signal are output from a second timer by interrupt processing.

FIG. 10 is a diagram illustrating operation of a third timer.

FIG. 11 is a diagram illustrating a correspondence relationship between a mechanical angle and an edge count value.

FIG. 12 is a timing chart illustrating an example of three-phase pulse signals PU, PV, and PW generated by the arithmetic device of the processing device.

FIG. 13 is a flowchart illustrating another example of the offline processing executed by the arithmetic device of the processing device.

FIG. 14 is a diagram illustrating an example of a waveform of three-phase induced voltages Vu, Vv, and Vw.

FIG. 15 is a timing chart illustrating an example of the three-phase pulse signals PU, PV, and PW generated by the arithmetic device of the processing device.

### DESCRIPTION OF EMBODIMENT

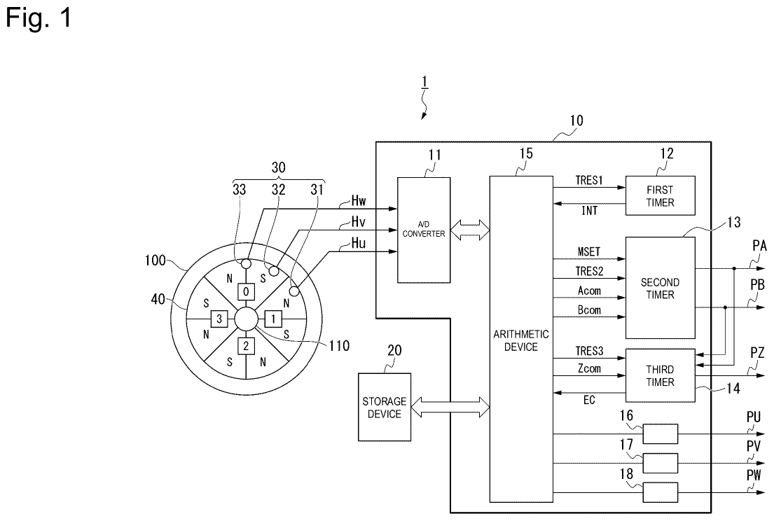

An embodiment of the present invention will be described in detail below with reference to the drawings. FIG. 1 is a block diagram schematically illustrating a configuration of an angle detection device 1 according to the present embodiment. As illustrated in FIG. 1, the angle detection device 1 is a device that detects a mechanical angle θ of a rotor shaft 110 that is a rotation shaft of an N-phase motor 100 (N is an integer of three or more) having a rotor magnet (not illustrated). As an example, the N-phase motor 100 is an inner rotor type three-phase brushless DC motor. Hereinafter, the N-phase motor 100 is referred to as the “three-phase motor 100”. The three-phase motor 100 is a sensorless motor not incorporating a position sensor.

The angle detection device 1 includes a processing device 10, a storage device 20, a sensor group 30, and a sensor magnet 40. The sensor magnet 40 is a disc-shaped magnet attached to a rotor shaft 110 in a state of facing a rotor magnet of the three-phase motor 100. The sensor magnet 40 rotates in synchronization with the rotor shaft 110. The sensor magnet 40 has P (P is an integer of one or more) magnetic pole pairs.

As an example, in the present embodiment, the sensor magnet 40 has four magnetic pole pairs. Note that the magnetic pole pair means a pair of an N pole and an S pole. That is, in the present embodiment, the sensor magnet 40 has four pairs of N poles and S poles, and has a total of eight magnetic poles. The number of pole pairs of the rotor magnet may be the same as or different from the number P of pole pairs of the sensor magnet 40. As an example, in the present embodiment, the number of pole pairs of the rotor magnet is the same as the number P of pole pairs of the sensor magnet 40.

Although not illustrated in FIG. 1, a circuit board is mounted on the three-phase motor 100, and the processing device 10, the storage device 20, and the sensor group 30 are arranged on the circuit board. The sensor magnet 40 is disposed at a position not interfering with the circuit board. The sensor magnet 40 may be disposed inside a housing of the three-phase motor 100 or may be disposed outside the housing.

The sensor group 30 includes M (M is an integer of three or more) magnetic sensors that detect a magnetic flux change due to rotation of the sensor magnet 40. As an example, in the present embodiment, the sensor group 30 includes three magnetic sensors including a first magnetic sensor 31, a second magnetic sensor 32, and a third magnetic sensor 33. For example, the first magnetic sensor 31, the second magnetic sensor 32, and the third magnetic sensor 33 are disposed in a state of facing the sensor magnet 40 on the circuit board.

In the present embodiment, the first magnetic sensor 31, the second magnetic sensor 32, and the third magnetic sensor 33 are disposed at intervals of 30 degrees along a rotation direction of the sensor magnet 40 on the circuit board. For example, each of the first magnetic sensor 31, the second magnetic sensor 32, and the third magnetic sensor 33 is an analog output type magnetic sensor including a magnetoresistive element such as a Hall element or a linear Hall IC. Each of the first magnetic sensor 31, the second magnetic sensor 32, and the third magnetic sensor 33 outputs an analog signal indicating magnetic field strength changing according to a rotational position of the rotor shaft 110, that is, a rotational position of the sensor magnet 40.

One electrical angle cycle of an analog signal output from the first magnetic sensor 31, the second magnetic sensor 32, and the third magnetic sensor 33 corresponds to 1/P of one mechanical angle cycle. In the present embodiment, since the number P of pole pairs of the sensor magnet 40 is “4”, one electrical angle cycle of each analog signal corresponds to ¼ of one mechanical angle cycle, that is, 90 degrees in mechanical angle. An analog signal output from the second magnetic sensor 32 has a phase delay of 120 degrees in electrical angle with respect to an analog signal output from the first magnetic sensor 31. An analog signal output from the third magnetic sensor 33 has a phase delay of 120 degrees in electrical angle with respect to an analog signal output from the second magnetic sensor 32.

Hereinafter, an analog signal output from the first magnetic sensor 31 is referred to as a U-phase sensor signal Hu, an analog signal output from the second magnetic sensor 32 is referred to as a V-phase sensor signal Hv, and an analog signal output from the third magnetic sensor 33 is referred to as a W-phase sensor signal Hw. The U-phase sensor signal Hu, the V-phase sensor signal Hv, and the W-phase sensor signal Hw are input to the processing device 10. Hereinafter, the U-phase sensor signal Hu, the V-phase sensor signal Hv, and the W-phase sensor signal Hw may be collectively referred to as “three-phase sensor signals”.

The processing device 10 is a microprocessor such as a microcontroller unit (MCU), for example. The processing device 10 calculates the mechanical angle θ of the rotor shaft 110 based on the three-phase sensor signals Hu, Hv, and Hw output from the sensor group 30. The processing device 10 generates an A-phase pulse signal PA and a B-phase pulse signal PB having a phase difference of 90 degrees in terms of electrical angle based on a calculated value of the mechanical angle θ. Further, the processing device 10 generates a Z-phase pulse signal PZ indicating the origin of the mechanical angle θ based on the A-phase pulse signal PA and the B-phase pulse signal PB.

Furthermore, the processing device 10 generates an N-phase pulse signal having a phase difference of 360 degrees divided by N in terms of electrical angle, based on a calculated value of the mechanical angle θ. In the present embodiment, since N is three, the processing device 10 generates three-phase pulse signals having a phase difference of 120 degrees in terms of electrical angle. The three-phase pulse signal includes a U-phase pulse signal PU, a V-phase pulse signal PV, and a W-phase pulse signal PW.

The processing device 10 includes an A/D converter 11, a first timer 12, a second timer 13, a third timer 14, an arithmetic device 15, a first output buffer circuit 16, a second output buffer circuit 17, and a third output buffer circuit 18.

The three-phase sensor signals Hu, Hv, and Hw output from the sensor group 30 are input to the A/D converter 11 of the processing device 10. The A/D converter 11 samples the three-phase sensor signals Hu, Hv, and Hw at a predetermined sampling frequency to convert the three-phase sensor signals Hu, Hv, and Hw into digital values, and outputs the digital values of the three-phase sensor signals Hu, Hv, and Hw to the arithmetic device 15.

The first timer 12 outputs an interrupt signal INT to the arithmetic device 15 at a predetermined cycle. Specifically, the first timer 12 increments a timer count value in synchronization with a clock signal not illustrated, and, when the timer count value reaches a timer reset value TRES1, outputs the interrupt signal INT and resets the timer count value. In this manner, a cycle at which the interrupt signal INT is output from the first timer 12 is determined by the timer reset value TRES1. The timer reset value TRES1 is set to the first timer 12 by the arithmetic device 15.

The second timer 13 outputs the A-phase pulse signal PA and the B-phase pulse signal PB. The second timer 13 has a high-level output mode, a low-level output mode, and a comparison output mode as output modes of the A-phase pulse signal PA and the B-phase pulse signal PB. When the output mode of the A-phase pulse signal PA is the high-level output mode, the second timer 13 sets a level of the A-phase pulse signal PA to a high level. When the output mode of the A-phase pulse signal PA is the low-level output mode, the second timer 13 sets a level of the A-phase pulse signal PA to a low level. The same applies to the B-phase pulse signal PB.

On the other hand, when the output mode is the comparison output mode, the second timer 13 increments a timer count value in synchronization with a clock signal (not illustrated), and resets the timer count value every time the timer count value reaches a timer reset value TRES2. When the output mode is the comparison output mode, the second timer 13 inverts a level of the A-phase pulse signal PA every time the timer count value reaches a first level inversion threshold Acom, and inverts a level of the B-phase pulse signal PB every time the timer count value reaches a second level inversion threshold Bcom.

The output mode of the second timer 13 is switched by an output mode setting signal MSET output from the arithmetic device 15 to the second timer 13. The timer reset value TRES2, the first level inversion threshold Acom, and the second level inversion threshold Bcom are set to the second timer 13 by the arithmetic device 15. Note that the A-phase pulse signal PA and the B-phase pulse signal PB output from the second timer 13 are input to the third timer 14.

The third timer 14 counts the number of edges of the A-phase pulse signal PA and the B-phase pulse signal PB output from the second timer 13. The third timer 14 resets a count value of the number of edges when the count value of the number of edges reaches a predetermined timer reset value TRES3. Hereinafter, a count value of the number of edges is referred to as an edge count value EC. The third timer 14 compares the edge count value EC with a predetermined Z-phase output threshold Zcom, and outputs, as the Z-phase pulse signal PZ indicating the origin of the mechanical angle θ, a signal that becomes a high level when the edge count value EC is smaller than the Z-phase output threshold Zcom. The timer reset value TRES3 and the Z-phase output threshold Zcom are set to the third timer 14 by the arithmetic device 15. The third timer 14 outputs the edge count value EC to the arithmetic device 15.

The arithmetic device 15 is a processor core that executes various types of processing in accordance with a program stored in the storage device 20. For example, the arithmetic device 15 executes, as offline processing, learning processing of acquiring learning data necessary for calculation of the machine angle θ of the rotor shaft 110 based on a digital values of the three-phase sensor signals Hu, Hv, and Hw input from the A/D converter 11. The offline processing is processing executed before the angle detection device 1 is shipped from a manufacturing factory or before the angle detection device 1 is incorporated in a system on the customer side and is actually operated.

Further, the arithmetic device 15 executes angle calculation processing of calculating the mechanical angle θ of the rotor shaft 110 based on a digital values of the three-phase sensor signals Hu, Hv, and Hw and learning data obtained by learning processing as one piece of the online processing. The online processing is processing executed when the angle detection device 1 is incorporated in a system on the customer side and is actually operated.

As one piece of the online processing, the arithmetic device 15 performs interrupt processing of controlling an output mode of the second timer 13 every time the interrupt signal INT is generated from the first timer 12. The arithmetic device 15 controls an output mode of the second timer 13 based on the mechanical angle θ, so that the A-phase pulse signal PA and the B-phase pulse signal PB are output from the second timer 13. When the A-phase pulse signal PA and the B-phase pulse signal PB are output from the second timer 13, the Z-phase pulse signal PZ is automatically output from the third timer 14.

Furthermore, the arithmetic device 15 performs signal generation processing of generating the U-phase pulse signal PU, the V-phase pulse signal PV, and the W-phase pulse signal PW based on a calculated value of the mechanical angle θ as one piece of the online processing. The arithmetic device 15 outputs the U-phase pulse signal PU to the outside of the processing device 10 via the first output buffer circuit 16. The arithmetic device 15 outputs the V-phase pulse signal PV to the outside of the processing device 10 via the second output buffer circuit 17. The arithmetic device 15 outputs the W-phase pulse signal PW to the outside of the processing device 10 via the third output buffer circuit 18.

The storage device 20 includes a nonvolatile memory that stores, in advance, a program, a setting value, and the like necessary for causing the arithmetic device 15 to execute various types of processing, and a volatile memory used as a temporary storage destination of data when the arithmetic device 15 executes various types of processing. As an example, the nonvolatile memory is an electrically erasable programmable read-only memory (EEPROM), a flash memory, or the like, and the volatile memory is a random access memory (RAM) or the like. The storage device 20 may be incorporated in the processing device 10.

The nonvolatile memory of the storage device 20 stores, as setting values, the timer reset value TRES1 of the first timer 12, the timer reset value TRES3 of the third timer 14, a Z-phase output threshold Zth, and the like. Although details will be described later, the timer reset value TRES2 of the second timer 13, the first level inversion threshold Acom, and the second level inversion threshold Bcom are calculated by the arithmetic device 15.

Although details will be described later, the storage device 20 stores a relational expression representing a relationship between output values of three of the magnetic sensors 31, 32, and 33 (digital values of the three-phase sensor signals Hu, Hv, and Hw) and the mechanical angle θ of the rotor shaft 110, and the mechanical angle θ corresponding to at least one rotational position of the rotor magnet as a level switching angle. The relational expression and the level switching angle are included in learning data obtained by the arithmetic device 15 performing learning processing.

The arithmetic device 15 calculates the mechanical angle θ based on digital values of the three-phase sensor signals Hu, Hv, and Hw and the relational expression, and outputs the three-phase pulse signals PU, PV, and PW having a phase difference of 120 degrees in terms of electrical angle based on the calculated value of the mechanical angle θ and the level switching angle at the time of execution of the signal generation processing which is one piece of the online processing. When a calculated value of the mechanical angle θ matches with a level switching angle, the arithmetic device 15 switches a level of a pulse signal of any one phase of the three-phase pulse signals PU, PV, and PW.

The processing device 10 including the arithmetic device 15 as described above has a function of calculating the mechanical angle θ based on digital values of the three-phase sensor signals Hu, Hv, and Hw and the relational expression and outputting the three-phase pulse signals PU, PV, and PW having a phase difference of 120 degrees in terms of electrical angle based on the calculated value of the mechanical angle θ and the level switching angle, and a function of switching a level of a pulse signal of any one phase of the three-phase pulse signals PU, PV, and PW when a calculated value of the mechanical angle θ matches with a level switching angle.

The configuration of the angle detection device 1 is described above. Hereinafter, before describing operation of the processing device 10, a position estimation method disclosed in JP 6233532 B2 will be briefly described in order to facilitate understanding of the present invention. In description below, the position estimation method disclosed in JP 6233532 B2 may be referred to as a basic patent method. For details of the basic patent method, refer to JP 6233532 B2. Note that, hereinafter, for convenience of description, the basic patent method will be described using each element illustrated in FIG. 1.

First, learning processing executed by the arithmetic device 15 in the basic patent method will be described.

When starting the learning processing, the arithmetic device 15 acquires digital values (instantaneous values) of the three-phase sensor signals Hu, Hv, and Hw output from the magnetic sensors 31, 32, and 33 in a state where the sensor magnet 40 is rotated together with the rotor shaft 110. Specifically, the arithmetic device 15 acquires digital values of the three-phase sensor signals Hu, Hv, and Hw by digitally converting each of the three-phase sensor signals Hu, Hv, and Hw at a predetermined sampling frequency by the A/D converter 11.

Note that at the time of execution of the learning processing, the rotor shaft 110 may be rotated by control of the three-phase motor 100 via a motor control device (not illustrated). Alternatively, the rotor shaft 110 may be connected to a rotating machine (not illustrated), and the rotating machine may rotate the rotor shaft 110.

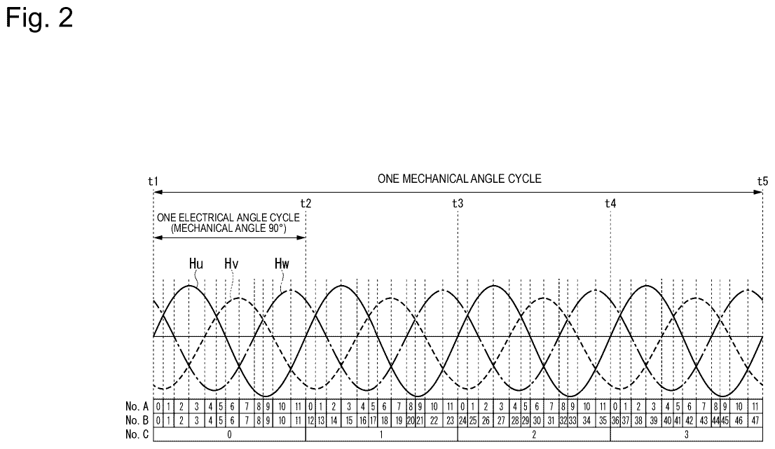

FIG. 2 is a diagram illustrating an example of a waveform of the U-phase sensor signal Hu, the V-phase sensor signal Hv, and the W-phase sensor signal Hw. As illustrated in FIG. 2, one electrical angle cycle of each of the three-phase sensor signals Hu, Hv, and Hw corresponds to ¼ of one mechanical angle cycle, that is, 90 degrees in terms of mechanical angle. In FIG. 2, a period from a time t1 to a time t5 corresponds to one mechanical angle cycle (360 degrees in mechanical angle). In FIG. 2, each of a period from the time t1 to the time t2, a period from the time t2 to the time t3, a period from the time t3 to the time t4, and a period from the time t4 to the time t5 corresponds to 90 degrees in mechanical angle. Further, the three-phase sensor signals Hu, Hv, and Hw have a phase difference of 120 degrees in electrical angle with one another.

Based on digital values of the three-phase sensor signals Hu, Hv, and Hw, the arithmetic device 15 extracts, over one mechanical angle cycle, an intersection point at which signals of two phases among the three-phase sensor signals Hu, Hv, and Hw intersect each other and a zero-cross point at which each of the three-phase sensor signals Hu, Hv, and Hw intersects a reference signal level (reference potential). The reference signal level is, for example, a ground level (0 V). In a case where the reference signal level is the ground level, a digital value of the reference signal level is “0”.

As illustrated in FIG. 2, the arithmetic device 15 divides one mechanical angle cycle into four pole pair regions associated with pole pair numbers based on an extraction result of a zero-cross point. In FIG. 2, “No. C” indicates a pole pair number. As illustrated in FIG. 1, pole pair numbers are assigned in advance to four magnetic pole pairs of the sensor magnet 40. For example, a magnetic pole pair provided in a range of 0 to 90 degrees in mechanical angle is assigned a pole pair number “0”. A magnetic pole pair provided in a range of 90 to 180 degrees in mechanical angle is assigned a pole pair number “1”. A magnetic pole pair provided in a range of 180 to 270 degrees in mechanical angle is assigned a pole pair number “2”. A magnetic pole pair provided in a range of 270 to 360 degrees in mechanical angle is assigned a pole pair number “3”.

For example, in a case where the U-phase sensor signal Hu is used as a reference, the arithmetic device 15 recognizes a zero-cross point obtained at a sampling timing (the time t1) at which the mechanical angle is 0 degrees among zero-cross points of the U-phase sensor signal Hu as a start point of a pole pair region associated with the pole pair number “0”. Further, the arithmetic device 15 recognizes a zero-cross point obtained at a sampling timing (the time t2) at which the mechanical angle is 90 degrees among zero-cross points of the U-phase sensor signal Hu as an end point of the pole pair region associated with the pole pair number “0”. That is, the arithmetic device 15 determines an interval between a zero-cross point obtained at the time t1 and a zero-cross point obtained at the time t2 as a pole pair region associated with the pole pair number “0”.

The arithmetic device 15 also recognizes a zero-cross point obtained at a sampling timing (the time t2) at which the mechanical angle is 90 degrees among zero-cross points of the U-phase sensor signal Hu as a start point of a pole pair region associated with the pole pair number “1”. Further, the arithmetic device 15 recognizes a zero-cross point obtained at a sampling timing (the time t3) at which the mechanical angle is 180 degrees among zero-cross points of the U-phase sensor signal Hu as an end point of the pole pair region associated with the pole pair number “1”. That is, the arithmetic device 15 determines an interval between a zero-cross point obtained at the time t2 and a zero-cross point obtained at the time t3 as the pole pair region associated with the pole pair number “1”.

The arithmetic device 15 also recognizes a zero-cross point obtained at a sampling timing (the time t3) at which the mechanical angle is 180 degrees among zero-cross points of the U-phase sensor signal Hu as a start point of a pole pair region associated with the pole pair number “2”. Further, the arithmetic device 15 recognizes a zero-cross point obtained at a sampling timing (the time t4) at which the mechanical angle is 270 degrees among zero-cross points of the U-phase sensor signal Hu as an end point of the pole pair region associated with the pole pair number “2”. That is, the arithmetic device 15 determines an interval between a zero-cross point obtained at the time t3 and a zero-cross point obtained at the time t4 as the pole pair region associated with the pole pair number “2”.

The arithmetic device 15 also recognizes a zero-cross point obtained at a sampling timing (the time t4) at which the mechanical angle is 270 degrees among zero-cross points of the U-phase sensor signal Hu as a start point of a pole pair region associated with the pole pair number “3”. Further, the arithmetic device 15 recognizes a zero-cross point obtained at a sampling timing (the time t5) at which the mechanical angle is 360 degrees among zero-cross points of the U-phase sensor signal Hu as an end point of the pole pair region associated with the pole pair number “3”. That is, the arithmetic device 15 determines an interval between a zero-cross point obtained at the time t4 and a zero-cross point obtained at the time t5 as the pole pair region associated with the pole pair number “3”.

As illustrated in FIG. 2, the arithmetic device 15 divides each of the four pole pair regions into 12 sections associated with section numbers based on extraction results of an intersection point and a zero-cross point. In FIG. 2, “No. A” indicates a section number associated with each section. As illustrated in FIG. 2, 12 sections included in each of four pole pair regions are assigned with section numbers from “0” to “11”.

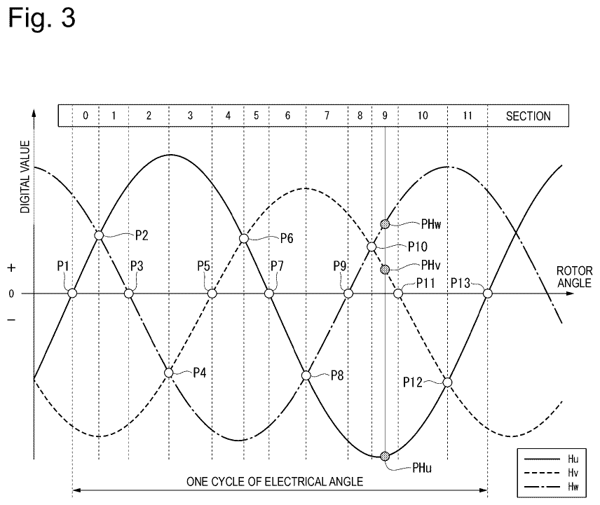

FIG. 3 is an enlarged view of the three-phase sensor signals Hu, Hv, and Hw included in one pole pair region illustrated in FIG. 2. In FIG. 3, a reference value (reference signal level) of an amplitude is “0”. In FIG. 3, a digital value of an amplitude that is a positive value represents a digital value of magnetic field strength of an N pole, as an example. Further, a digital value of an amplitude that is a negative value represents a digital value of magnetic field strength of an S pole, as an example.

In FIG. 3, points P1, P3, P5, P7, P9, P11, and P13 are zero-cross points extracted from digital values of the three-phase sensor signals Hu, Hv, and Hw included in one pole pair region. In FIG. 3, points P2, P4, P6, P8, P10, and P12 are intersection points extracted from digital values of the three-phase sensor signals Hu, Hv, and Hw included in one pole pair region. As illustrated in FIG. 3, the arithmetic device 15 determines, as a section, an interval between a zero-cross point and an intersection point adjacent to each other.

The arithmetic device 15 determines an interval between the zero-cross point P1 and the intersection point P2 as a section assigned with a section number “0”. The arithmetic device 15 determines an interval between the intersection point P2 and the zero-cross point P3 as a section assigned with a section number “1”. The arithmetic device 15 determines an interval between the zero-cross point P3 and the intersection point P4 as a section assigned with a section number “2”. The arithmetic device 15 determines an interval between the intersection point P4 and the zero-cross point P5 as a section assigned with a section number “3”. The arithmetic device 15 determines an interval between the zero-cross point P5 and the intersection point P6 as a section assigned with a section number “4”. The arithmetic device 15 determines an interval between the intersection point P6 and the zero-cross point P7 as a section assigned with a section number “5”.

The arithmetic device 15 determines an interval between the zero-cross point P7 and the intersection point P8 as a section assigned with a section number “6”. The arithmetic device 15 determines an interval between the intersection point P8 and the zero-cross point P9 as a section assigned with a section number “7”. The arithmetic device 15 determines an interval between the zero-cross point P9 and the intersection point P10 as a section assigned with a section number “8”. The arithmetic device 15 determines an interval between the intersection point P10 and the zero-cross point P11 as a section assigned with a section number “9”. The arithmetic device 15 determines an interval between the zero-cross point P11 and the intersection point P12 as a section assigned with a section number “10”. The arithmetic device 15 determines an interval between the intersection point P12 and the zero-cross point P13 as a section assigned with a section number “11”.

Note that in description below, for example, a section assigned with the section number “0” will be referred to as “0th section”, and a section assigned with the section number “11” will be referred to as “11th section”.

As illustrated in FIG. 2, numbers continuous over the entire period of one mechanical angle cycle are associated with section numbers as segment numbers. In FIG. 2, “No. B” indicates a segment number associated with each section number. Note that the segment is a term representing a straight line connecting an intersection point and a zero-cross point adjacent to each other. In other words, a straight line connecting a start point and an end point of each section is called a segment. In FIG. 3, for example, a start point of a 0th section is the zero-cross point P1, and an end point of the 0th section is the intersection point P2. Therefore, a segment corresponding to the 0th section is a straight line connecting the zero-cross point P1 and the intersection point P2. Similarly, in FIG. 3, for example, a start point of a 1st section is the intersection point P2, and an end point of the 1st section is the zero-cross point P3. Therefore, a segment corresponding to the 1st section is a straight line connecting the intersection point P2 and the zero-cross point P3.

As illustrated in FIG. 2, in a pole pair region associated with a pole pair number “0”, section numbers “0” to “11” are associated with segment numbers “0” to “11”. In a pole pair region associated with a pole pair number “1”, section numbers “0” to “11” are associated with segment numbers “12” to “23”. In a pole pair region associated with a pole pair number “2”, section numbers “0” to “11” are associated with segment numbers “24” to “35”. In a pole pair region associated with a pole pair number “3”, section numbers “0” to “11” are associated with segment numbers “36” to “47”.

Note that, in description below, for example, a segment to which the segment number “0” is assigned will be referred to as “0th segment”, and a segment to which a segment number “11” is assigned will be referred to as “11th segment”.

The arithmetic device 15 generates a linear function θ(Δx) representing each segment. Δx is a length (digital value) from a start point of a segment to any point on the segment, and θ is a mechanical angle corresponding to any point on the segment. In FIG. 3, for example, a start point of a segment corresponding to a 0th section is the zero-cross point P1, and an end point of the segment corresponding to the 0th section is the intersection point P2. Similarly, in FIG. 3, for example, a start point of a segment corresponding to a 1st section is the intersection point P2, and an end point of the segment corresponding to the 1st section is the zero-cross point P3.

For example, the linear function θ(Δx) representing a segment is expressed by Expression (1) below. In Expression (1) below, “i” is a segment number and is an integer from 0 to 47. In description below, the linear function θ(Δx) expressed by Expression (1) below may be referred to as a mechanical angle arithmetic expression.

$$θ ( Δ x ) = k [ i ] \times Δ x + θ res [ i ] \qquad ( 1 )$$

In Expression (1) above, k[i] is a coefficient called a normalization coefficient. In other words, k[i] is a coefficient representing a slope of an i-th segment. The normalization coefficient k[i] is expressed by Expression (2) below. In Expression (2) below, ΔXnorm[i] is deviation of a digital value between a start point and an end point of the i-th segment. In FIG. 3, for example, ΔXnorm[i] of a segment corresponding to the 0th section is deviation of a digital value between the zero-cross point P1 and the intersection point P2. Similarly, in FIG. 3, for example, ΔXnorm[i] of a segment corresponding to the 1st section is deviation of a digital value between the intersection point P2 and the zero-cross point P3.

$$k [ i ] = θ norm [ i ] / Δ X norm [ i ] \qquad ( 2 )$$

In Expression (2) above, θnorm[i] is deviation of a mechanical angle between a start point and an end point of the i-th segment, and is expressed by Expression (3) below. In Expression (3) below, t[i] is time between a start point and an end point of the i-th segment, t[0] is time between a start point and an end point of the 0th segment, and t[47] is time between a start point and an end point of the 47th segment. In FIG. 3, for example, when a segment corresponding to the 0th section is the 0th segment, t[0] is time between the zero-cross point P1 and the intersection point P2.

$$θ norm [ i ] = \{ t [ i ] / ( t [ 0 ] + … + t [ 47 ] ) \} \times 360 [ degM ] \qquad ( 3 )$$

In Expression (1) above, θres[i] is a constant called an angle reset value of the i-th segment (an intercept of the linear function θ(Δx)). When the segment number “i” is “0”, the angle reset value θres[i] is expressed by Expression (4) below. When the segment number “i” is any of “1” to “47”, the angle reset value θres[i] is expressed by Expression (5) below. Instead of obtaining θnorm[i] from t[i] as described above, θnorm[i] may be obtained from a mechanical angle true value (mechanical angle indicated, for example, by an output signal of a master encoder attached to the rotor shaft 110 at the time of execution of learning processing).

$$θ res [ i ] = 0 [ degM ] \qquad ( 4 )$$

$$θ res [ i ] = Σ ( θ norm [ i - 1 ] ) \qquad ( 5 )$$

By performing the learning processing as described above, the arithmetic device 15 acquires a correspondence relationship between a pole pair number, a section number, and a segment number, feature data of each section, and a mechanical angle arithmetic expression of each segment, and stores the acquired data in the storage device 20 as learning data. Note that the feature data of each section is a magnitude relationship between digital values of the three-phase sensor signals Hu, Hv, and Hw included in each section, positive and negative signs, and the like. Further, the normalization coefficient k[i] and the angle reset value θres[i] constituting a mechanical angle arithmetic expression of each segment are stored in the storage device 20 as learning data. The mechanical angle arithmetic expression corresponds to a relational expression representing a relationship between digital values of the three-phase sensor signals Hu, Hv, and Hw and the mechanical angle θ.

Next, angle calculation processing executed by the arithmetic device 15 in the basic patent method will be described.

When starting the angle calculation processing, the arithmetic device 15 acquires digital values of the three-phase sensor signals Hu, Hv, and Hw output from the magnetic sensors 31, 32, and 33. Specifically, the arithmetic device 15 acquires digital values of the three-phase sensor signals Hu, Hv, and Hw by digitally converting each of the three-phase sensor signals Hu, Hv, and Hw at a predetermined sampling frequency by the A/D converter 11.

Then, the arithmetic device 15 identifies a current section number and pole pair number based on digital values of the three-phase sensor signals Hu, Hv, and Hw obtained at a sampling timing this time. For example, in FIG. 3, a point PHu located on a waveform of the U-phase sensor signal Hu, a point PHv located on a waveform of the V-phase sensor signal Hv, and a point PHw located on a waveform of the W-phase sensor signal Hw are assumed to be digital values of the three-phase sensor signals Hu, Hv, and Hw obtained at a sampling timing this time. The arithmetic device 15 identifies a current section (section number) by collating feature data such as a magnitude relationship and positive and negative signs of digital values of the point PHu, the point PHv, and the point PHw with feature data of each section included in learning data stored in the storage device 20. In the example of FIG. 3, the 9th section is identified as the current section. Note that, in the present description, a method of identifying a pole pair number will not be described. For a method of identifying a pole pair number, refer to JP 6233532 B2. It is assumed that, for example, the pole pair number “2” is identified as a pole pair number at a sampling timing this time.

Then, the arithmetic device 15 identifies a current segment number based on the identified current section number and pole pair number. For example, the arithmetic device 15 identifies a current segment number by an expression of “segment number=12×pole pair number+section number”. As described above, it is assumed that the section number “9” is identified as a current section number, and the pole pair number “2” is identified as a current pole pair number. In this case, the arithmetic device 15 identifies the segment number “33” as a current segment number (see FIG. 2).

The arithmetic device 15 reads the normalization coefficient k[i] and the angle reset value θres[i] corresponding to the identified segment number “i” from learning data stored in the storage device 20, and calculates the mechanical angle θ by the mechanical angle arithmetic expression represented by Expression (1) above. Here, as Δx to be substituted into the mechanical angle arithmetic expression, digital values of the three-phase sensor signals Hu, Hv, and Hw corresponding to the identified segment are used. For example, as described above, in a case where the segment number “33” is identified as a current segment number, the arithmetic device 15 reads a normalization coefficient k and an angle reset value θres from the storage device 20, and substitutes a digital value (see FIG. 3) of the point PHv as Δx into the mechanical angle arithmetic expression to calculate the mechanical angle θ at a sampling timing this time.

The above is description of the basic patent method on which the present invention is based. Hereinafter, operation of the processing device 10 will be described in detail. First, a first example of operation of the processing device 10 will be described.

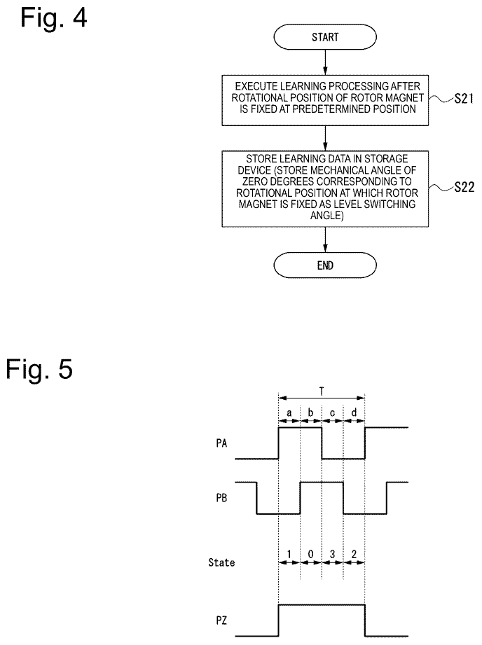

FIG. 4 is a flowchart illustrating offline processing executed by the arithmetic device 15 of the processing device 10 in the first example. As illustrated in FIG. 4, the arithmetic device 15 executes the learning processing described above after a rotational position of the rotor shaft 110, that is, the rotor magnet is fixed at a predetermined position (Step S21). For example, before the arithmetic device 15 executes the learning process, a motor control device (not illustrated) causes predetermined current to flow from a stator coil of one phase to a stator coil of a remaining phase among stator coils of three phases of the three-phase motor 100, so as to fix a rotational position of a rotor magnet at a predetermined position.

Specifically, the motor control device causes rated current to flow from a stator coil of a U phase to remaining stator coils of a V phase and a W phase among stator coils of three phases of the three-phase motor 100, so as to fix a rotational position of the rotor magnet at a predetermined position. Hereinafter, flowing predetermined current from a stator coil of one phase to stator coils of remaining phases among stator coils of three phases of the three-phase motor 100 is referred to as “d-axis current conduction”.

The arithmetic device 15 executes learning processing after a rotational position of a rotor magnet is fixed to a predetermined position, so as to acquire, as learning data, a correspondence relationship between a pole pair number, a section number, and a segment number, feature data of each section, a mechanical angle arithmetic expression (the normalization coefficient k[i] and the angle reset value θres[i]) of each segment, and the like.

As described above, the d-axis current conduction is performed on the three-phase motor 100 before learning processing is executed, and a rotational position of a rotor magnet is fixed at a predetermined position, so that any one pole pair of a plurality of pole pairs included in the rotor magnet becomes the origin (mechanical angle of zero degrees). Therefore, the mechanical angle of zero degrees indicated by an angle reset value θres[0] of the 0th segment obtained by learning processing is a mechanical angle of zero degrees corresponding to the origin of the rotor magnet (rotor shaft 110).

Then, the arithmetic device 15 stores learning data acquired by the learning processing in Step S21 in the storage device 20 (Step S22). By the above, the mechanical angle of zero degrees (that is, the angle reset value θres[0]) corresponding to a rotational position (that is, the origin) at which the rotor magnet is fixed by the d-axis current conduction is stored in the storage device 20 as the level switching angle.

As the offline processing described above is executed by the arithmetic device 15, the storage device 20 stores a relational expression (mechanical angle arithmetic expression) representing a relationship between output values (digital values of the three-phase sensor signals Hu, Hv, and Hw) of three of the magnetic sensors 31, 32, and 33 and the mechanical angle θ of the rotor shaft 110 and the mechanical angle θ corresponding to at least one rotational position of the rotor magnet as the level switching angle. More specifically, the storage device 20 stores, as the level switching angle, the mechanical angle of zero degrees (angle reset value θres[0]) corresponding to a rotational position (the origin) where the rotor magnet is fixed by the d-axis current conduction.

Next, the angle calculation processing and the interrupt processing executed as the online processing by the arithmetic device 15 in the first example in order to generate the A-phase pulse signal PA, the B-phase pulse signal PB, and the Z-phase pulse signal PZ will be described with reference to FIGS. 5 to 11.

FIG. 5 is a diagram illustrating an example of a relationship between a waveform of the A-phase pulse signal PA, a waveform of the B-phase pulse signal PB, a waveform of the Z-phase pulse signal PZ, and a signal state value State. In FIG. 5, when a cycle of the A-phase pulse signal PA is “T”, each of lengths of “a”, “b”, “c”, and “d” is T/4. As illustrated in FIG. 5, the B-phase pulse signal PB has delay time of T/4 with respect to the A-phase pulse signal PA. As described above, there is a phase difference of 90 degrees in electrical angle between the A-phase pulse signal PA and the B-phase pulse signal PB. A rising edge of the Z-phase pulse signal PZ occurs in synchronization with a rising edge of the A-phase pulse signal PA. A pulse width of the Z-phase pulse signal PZ can be adjusted to an optional value by the Z-phase output threshold Zcom.

Note that, although details will be described later, the signal state value State illustrated in FIG. 5 is a value calculated by the arithmetic device 15 based on the edge count value EC in the above-described interrupt processing. The signal state value State represents a relationship between a level of the A-phase pulse signal PA and a level of the B-phase pulse signal PB. For example, in a case where the signal state value State is “0”, the signal state value State represents a state in which both the A-phase pulse signal PA and the B-phase pulse signal PB are at a high level. In a case where the signal state value State is “1”, the signal state value State represents a state in which the A-phase pulse signal PA is at a high level and the B-phase pulse signal PB is at a low level. In a case where the signal state value State is “2”, the signal state value State represents a state in which both the A-phase pulse signal PA and the B-phase pulse signal PB are at a low level. In a case where the signal state value State is “3”, the signal state value State represents a state in which the A-phase pulse signal PA is at a low level and the B-phase pulse signal PB is at a high level.

When the processing device 10 is switched from a power-off state to a power-on state, the arithmetic device 15 executes predetermined initialization processing. As one piece of the initialization processing, the arithmetic device 15 reads the timer reset value TRES1 of the first timer 12 from the storage device 20, and sets the read timer reset value TRES1 to the first timer 12. Further, as one piece of the initialization processing, the arithmetic device 15 reads the timer reset value TRES3 of the third timer 14 and the Z-phase output threshold Zcom from the storage device 20, and sets, to the third timer 14, the timer reset value TRES3 and the Z-phase output threshold Zcom that are read. Furthermore, as one piece of initialization processing, the arithmetic device 15 sets an edge count value of the third timer 14 to an initial value in accordance with the mechanical angle θ, and details of this setting processing will be described later.

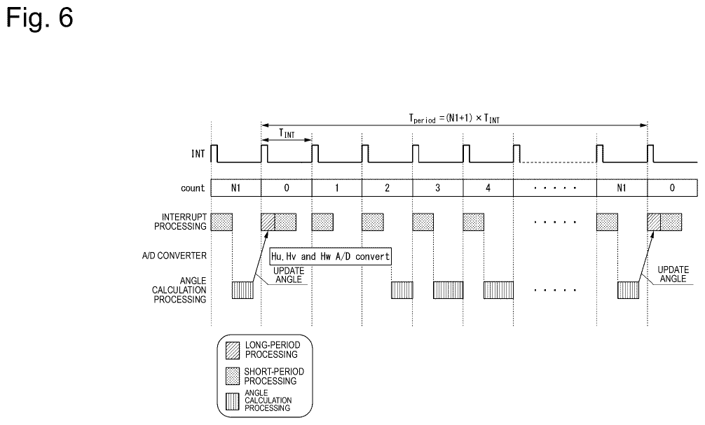

FIG. 6 is a timing chart showing a temporal correspondence relationship between an occurrence timing of the interrupt signal INT, a change timing of an interrupt frequency count, an execution timing of the interrupt processing, an operation timing of the A/D converter 11, and an execution timing of the angle calculation processing.

When the timer reset value TRES1 is set to the first timer 12, the first timer 12 increments a timer count value in synchronization with a clock signal (not illustrated), and when the timer count value reaches the timer reset value TRES1, the first timer 12 outputs the interrupt signal INT and resets the timer count value. By the above, as illustrated in FIG. 6, the interrupt signal INT is output from the first timer 12 at a predetermined cycle TINT.

As illustrated in FIG. 6, the arithmetic device 15 performs the interrupt processing every time the interrupt signal INT occurs. In a case where the interrupt frequency count, which is the number of times of occurrence of the interrupt signal INT, is equal to an initial value “0” at the start of the interrupt processing, the arithmetic device 15 performs predetermined short-period processing after performing predetermined long-period processing. On the other hand, in a case where the interrupt frequency count is not equal to the initial value “0”, the arithmetic device 15 performs the short-period processing without executing the long-period processing.

As illustrated in FIG. 6, when exceeding a maximum value “N1”, the interrupt frequency count is reset to the initial value “0”. In this manner, a cycle T_{period} in which the interrupt frequency count is reset is referred to as a “control cycle”. A control cycle T_{period} is expressed by Expression (6) below. The long-period processing included in the interrupt processing is processing repeatedly executed at a cycle equal to the control cycle T_{period}. The short-period processing included in the interrupt processing is processing repeatedly executed at a cycle equal to the occurrence cycle TINT of the interrupt signal INT.

$${T}_{period} = ( N 1 + 1 ) \times {T}_{I N T} \qquad ( 6 )$$

When the sensor magnet 40 rotates together with the rotor shaft 110, the three-phase sensor signals Hu, Hv, and Hw are output from the sensor group 30. As illustrated in FIG. 6, the A/D converter 11 starts digital conversion of the three-phase sensor signals Hu, Hv, and Hw when the interrupt frequency count is the initial value “0”, and ends the digital conversion when the interrupt frequency count is “2”, for example. That is, digital data of the three-phase sensor signals Hu, Hv, and Hw in one control cycle are obtained in a period where the interrupt frequency count changes from the initial value “0” to “2”. As illustrated in FIG. 6, when acquiring digital values of the three-phase sensor signals Hu, Hv, and Hw, the arithmetic device 15 calculates the mechanical angle θ of the rotor shaft 110 by executing the angle calculation processing in a period in which the interrupt processing is not executed.

As illustrated in FIG. 6, when the interrupt frequency count is the maximum value “N1”, the angle calculation processing executed within one control cycle ends. Upon completion of the angle calculation processing, the arithmetic device 15 stores a calculated value of the mechanical angle θ in the storage device 20. A cycle in which a calculated value of the machine angle θ is rewritten to a new value is equal to the control cycle T_{period}. In other words, the control cycle T_{period} is a cycle in which a calculated value of the mechanical angle θ is updated. As will be described later, a calculated value of the mechanical angle θ obtained when the interrupt frequency count is the maximum value “N1” is used in the interrupt processing executed when the interrupt frequency count is reset to the initial value “0”.

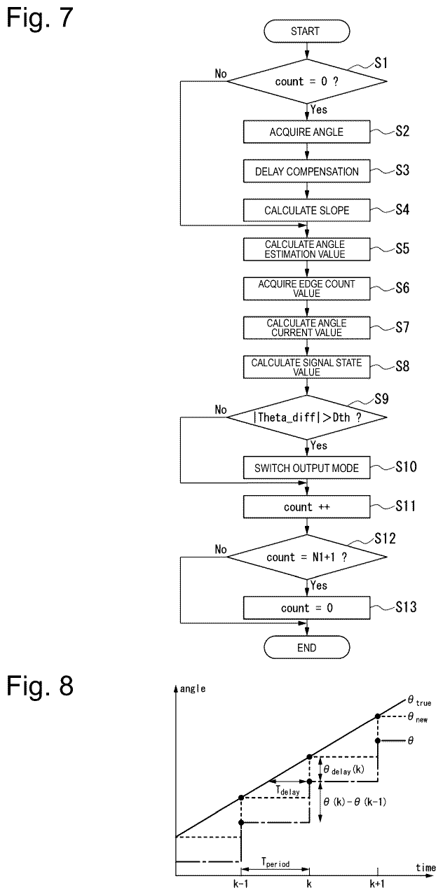

FIG. 7 is a flowchart illustrating the interrupt processing executed by the arithmetic device 15. As described above, when the interrupt signal INT is input from the first timer 12, the arithmetic device 15 executes the interrupt processing illustrated in FIG. 7. As illustrated in FIG. 7, upon starting the interrupt processing, the arithmetic device 15 first determines whether the interrupt frequency count is equal to the initial value “0” (Step S1). In a case of “Yes” in Step S1, that is, in a case where the interrupt frequency count is equal to the initial value “0”, the arithmetic device 15 proceeds to processing in Step S2. On the other hand, in a case of “No” in Step S1, that is, in a case where the interrupt frequency count is not equal to the initial value “0”, the arithmetic device 15 proceeds to processing in Step S5.

In the interrupt processing illustrated in FIG. 7, processing from Step S2 to Step S4 is the long-period processing. Further, in the interrupt processing illustrated in FIG. 7, processing from Step S5 to Step S13 is the short-period processing. That is, in a case where the interrupt frequency count is equal to the initial value “0”, the arithmetic device 15 executes the long-period processing including the processing from Step S2 to Step S4, and then executes the short-period processing including the processing from Step S5 to Step S13. On the other hand, in a case where the interrupt frequency count is not equal to the initial value “0”, the arithmetic device 15 executes the short-period processing without executing the long-period processing.

The arithmetic device 15 executes, as one piece of processing of the long-period processing, angle acquisition processing of acquiring a current value of the mechanical angle θ (Step S2). Specifically, in Step S2, the arithmetic device 15 acquires a calculated value of the mechanical angle θ stored in the storage device 20 as a current value Theta of the mechanical angle θ. As illustrated in FIG. 6, the current value Theta of the mechanical angle θ is a value of the mechanical angle θ calculated in a control cycle immediately before the current control cycle.

Next, the arithmetic device 15 executes, as one piece of processing of the long-period processing, function calculation processing of calculating a mechanical angle function expressing the mechanical angle θ as a linear function of time based on the current value Theta of the mechanical angle θ and a previous value Theta_prev of the mechanical angle θ (Steps S3 and S4). Note that the previous value Theta_prev of the mechanical angle θ is a value of the mechanical angle θ calculated in a control cycle two cycles before the current control cycle.

Specifically, the arithmetic device 15 executes, as one piece of the function calculation processing, intercept calculation processing of calculating an intercept of a mechanical angle function by performing delay compensation on the current value Theta of the mechanical angle θ (Step S3). The current value Theta of the mechanical angle θ includes a time delay component as described below. As described above, the current value Theta of the mechanical angle θ is a value of the mechanical angle θ calculated in a control cycle immediately before the current control cycle. For this reason, the current value Theta of the mechanical angle θ has a time delay corresponding to one control cycle. Further, the current value Theta of the mechanical angle θ has a time delay caused by a response delay of the magnetic sensors 31, 32, and 33. Furthermore, in a case where a low-pass filter is provided for the three-phase sensor signals Hu, Hv, and Hw, the current value Theta of the mechanical angle θ has a time delay caused by a frequency characteristic of the low-pass filter.

In Step S3, the arithmetic device 15 performs delay compensation on the current value Theta of the mechanical angle θ having a time delay component as described above. In FIG. 8, θ is the mechanical angle θ calculated by the angle calculation processing, θₜᵣᵤₑ is a true value of the mechanical angle θ, and θ_{new} is the delay-compensated mechanical angle θ. As illustrated in FIG. 8, when a time delay Tdelay exists in the mechanical angle θ, an angle error θ_{delay} occurs in the mechanical angle θ with respect to the true value θ_{new}. In this case, the delay-compensated mechanical angle θ_{new} is expressed by Expression (7) below. In Expression (7) below, θ(k) is equal to the current value Theta of the mechanical angle θ, and θ(k−1) is equal to the previous value Theta_prev of the mechanical angle θ. In Expression (7) below, the second term on the right side is equal to the angle error θ_{delay}.

$$\begin{matrix}[ Mathematical formula 1 ] & \\ {θ}_{new} ( k ) = θ ( k ) + \frac{{T}_{delay}}{{T}_{period}} \{ θ ( k ) - θ ( k - 1 ) \} & ( 7 )\end{matrix}$$

In Step S3, the arithmetic device 15 calculates, as an intercept of the mechanical angle function, the delay-compensated mechanical angle θ_{new} based on the above Expression (7). The arithmetic device 15 acquires, as an intercept Theta_new_low, a calculation result of the delay-compensated mechanical angle θ_{new}. Note that, as the time delay Tdelay included in Expression (7) above, a calculation value obtained by performing a simulation in consideration of the factor of the time delay described above may be used, or an actual measurement value obtained by conducting an experiment may be used.

Next, as one piece of the function calculation processing, the arithmetic device 15 executes slope calculation processing of calculating a slope of the mechanical angle function by subtracting the previous value Theta_prev from the current value Theta of the mechanical angle θ (Step S4). Specifically, in Step S4, the arithmetic device 15 calculates a slope Theta_extr of the mechanical angle function based on Expression (8) below.

$$Theta\_extr = Theta - Theta\_prev \qquad ( 8 )$$

By the arithmetic device 15 executing the function calculation processing including Steps S3 and S4 described above, a mechanical angle function θ(count) expressed by Expression (9) below is finally obtained.

$$θ ( count ) = Theta\_new \_low + Theta\_extr / ( N 1 + 1 ) \times count \qquad ( 9 )$$

The above processing from Step S2 to Step S4 is the long-period processing repeatedly executed at a cycle equal to the control cycle T_{period}. Subsequently, the short-period processing will be described.

The arithmetic device 15 executes, as one piece of the short-period processing, angle estimation value calculation processing of calculating an estimation value of the mechanical angle θ as an angle estimation value based on the mechanical angle function calculated by the function calculation processing (Step S5). Specifically, in Step S5, the arithmetic device 15 acquires, as an angle estimation value Theta_est, a value of θ(count) calculated by substituting a value of the interrupt frequency count into Expression (9) above.

Next, the arithmetic device 15 executes count value acquisition processing of acquiring the edge count value EC from the third timer 14 (Step S6), and executes angle current value calculation processing of calculating a current value of the mechanical angle θ as an angle current value based on the acquired edge count value EC (Step S7). Specifically, in Step S7, the arithmetic device 15 calculates an angle current value Theta_edge_now based on Expression (10) below.

Theta_edge_now=edge_now×EDGE2THETA (10)

In Expression (10) above, edge_now is a variable into which the edge count value EC is substituted. EDGE2THETA is a coefficient for converting the edge count value EC into, for example, a 32 bit angle. Assuming that the resolution of the processing device 10 is N_EDGE, EDGE2THETA is expressed by Expression (11) below. Note that the resolution is the number of edges occurring in the A-phase pulse signal PA and the B-phase pulse signal PB during one rotation of the rotor shaft 110.

$$EDGE 2 THETA = 2 \hat{} 32 / N\_EDGE \qquad ( 11 )$$

Next, the arithmetic device 15 executes signal state value calculation processing of calculating the signal state value State based on the edge count value EC (Step S8). As described already, the signal state value State is a value representing a relationship between a level of the A-phase pulse signal PA and a level of the B-phase pulse signal PB (see FIG. 5). Specifically, in Step S8, the arithmetic device 15 calculates the signal state value State based on Expression (12) below. Expression (12) below means that the logical product of a value of the variable edge_now and three (11 in binary representation) is calculated in order to acquire the lower two bits of the variable edge_now indicating the edge count value EC.

$$State = edge\_now \cdot ( 11 ) \qquad ( 12 )$$

Next, the arithmetic device 15 executes timing determination processing of determining whether or not it is a timing to change an output mode of the second timer 13 based on the angle estimation value Theta_est calculated in Step S5 and the angle current value Theta_edge_now calculated in Step S7 (Step S9). Specifically, in Step S9, the arithmetic device 15 determines whether or not an absolute value of a difference value Theta_diff_low obtained by subtracting the angle current value Theta_edge_now from the angle estimation value Theta_est is larger than a predetermined threshold Dth. Note that the arithmetic device 15 calculates the difference value Theta_diff_low based on Expression (13) below.

$$Theta\_diff \_low = Theta\_est - Theta\_edge \_now \qquad ( 13 )$$

In a case of “Yes” in Step S9, that is, in a case where an absolute value of the difference value Theta_diff_low is larger than the predetermined threshold Dth, the arithmetic device 15 determines that it is the timing to change the output mode of the second timer 13 and proceeds to the processing of Step S10. On the other hand, in a case of “No” in Step S9, that is, in a case where an absolute value of the difference value Theta_diff_low is equal to or less than the predetermined threshold Dth, the arithmetic device 15 proceeds to the processing of Step S11 without performing the processing of Step S10.

When it is determined that it is the timing to change an output mode in the timing determination processing, the arithmetic device 15 executes output mode switching processing of changing an output mode of one of the A-phase pulse signal PA and the B-phase pulse signal PB to one of a high-level output mode and a low-level output mode based on the signal state value State (Step S10).

Specifically, in Step S10, in a case where the signal state value State is “0”, the arithmetic device 15 sets both output modes of the A-phase pulse signal PA and the output mode of the B-phase pulse signal PB to the high-level output mode. In Step S10, in a case where the signal state value State is “1”, the arithmetic device 15 sets an output mode of the A-phase pulse signal PA to the high-level output mode and sets an output mode of the B-phase pulse signal PB to the low-level output mode. In Step S10, in a case where the signal state value State is “2”, the arithmetic device 15 sets both output modes of the A-phase pulse signal PA and the output mode of the B-phase pulse signal PB to the low-level output mode. In Step S10, in a case where the signal state value State is “3”, the arithmetic device 15 sets an output mode of the A-phase pulse signal PA to the low-level output mode and sets an output mode of the B-phase pulse signal PB to the high-level output mode.

After performing the processing of Step S10 or in a case of determining “No” in Step S9, the arithmetic device 15 executes interrupt frequency update processing of updating the interrupt frequency count (Step S11). Specifically, the arithmetic device 15 increments a value of the interrupt frequency count in Step S11.

Next, in a case where the updated interrupt frequency count is equal to a predetermined threshold Cth, the arithmetic device 15 executes interrupt frequency reset processing of resetting the interrupt frequency count to the initial value “0” (Steps S12 and S13). Specifically, the arithmetic device 15 determines whether or not the interrupt frequency count is equal to the threshold Cth (Step S12). The threshold Cth is obtained by adding “1” to the maximum value “N1” of the interrupt frequency count. In a case of “Yes” in Step S12, that is, in a case where the interrupt frequency count is equal to the threshold Cth (=N1+1), the arithmetic device 15 resets the interrupt frequency count to the initial value “0” and ends the interrupt processing (Step S13). On the other hand, in a case of “No” in Step S12, that is, in a case where the interrupt frequency count is not equal to the threshold Cth, the arithmetic device 15 ends the interrupt processing without executing processing in Step S13.

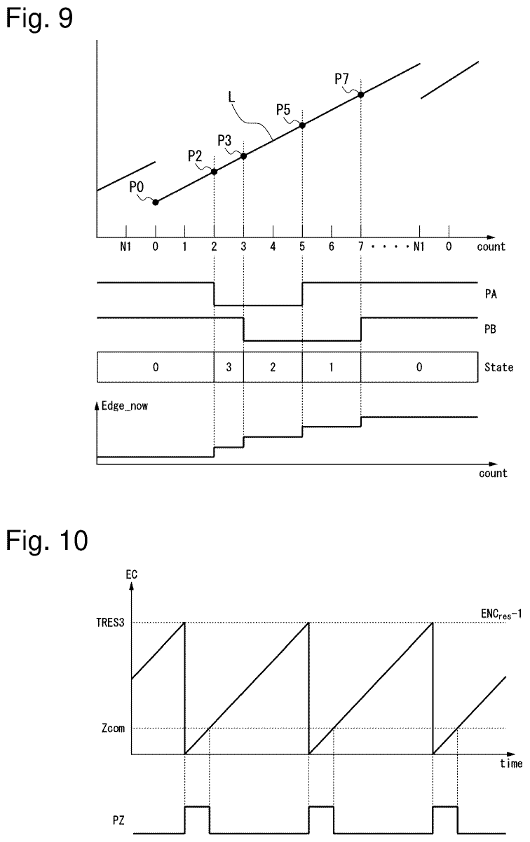

Every time the interrupt signal INT occurs, the arithmetic device 15 performs the interrupt processing as described above, so that the A-phase pulse signal PA and the B-phase pulse signal PB are output from the second timer 13. Hereinafter, an example in which the A-phase pulse signal PA and the B-phase pulse signal PB are output from the second timer 13 by the interrupt processing described above will be described with reference to FIG. 9.

In FIG. 9, a straight line L indicates the mechanical angle function θ(count) calculated when the interrupt frequency count is “0”. The straight line L has a slope that is the slope Theta_extr of the mechanical angle function θ(count). A value of a point P0 on the straight line L is the angle estimation value Theta_est calculated when the interrupt frequency count is “0”. A value of the point P0 is equal to the intercept Theta_new_low of the mechanical angle function θ(count). A value of a point P2 on the straight line L is the angle estimation value Theta_est calculated when the interrupt frequency count is “2”. A value of a point P3 on the straight line L is the angle estimation value Theta_est calculated when the interrupt frequency count is “3”. A value of a point P5 on the straight line L is the angle estimation value Theta_est calculated when the interrupt frequency count is “5”. A value of a point P7 on the straight line L is the angle estimation value Theta_est calculated when the interrupt frequency count is “7”.

As illustrated in FIG. 9, it is assumed that before the interrupt frequency count changes to “2”, the signal state value State is “0” and both output modes of the A-phase pulse signal PA and the output mode of the B-phase pulse signal PB are set to the high-level output mode. In this case, before the interrupt frequency count changes to “2”, both the A-phase pulse signal PA and the B-phase pulse signal PB output from the second timer 13 become a high level.

As illustrated in FIG. 9, it is assumed that when the interrupt frequency count changes to “2”, the signal state value State becomes “3” and an absolute value of the difference value Theta_diff_low between the angle estimation value Theta_est (value of the point P2) and the angle current value Theta_edge_now becomes larger than the threshold Dth. In this case, the arithmetic device 15 changes only an output mode of the A-phase pulse signal PA to the low-level output mode based on the signal state value State. As a result, as illustrated in FIG. 9, at a timing when the interrupt frequency count changes to “2”, only the A-phase pulse signal PA output from the second timer 13 changes to a low level.

As illustrated in FIG. 9, it is assumed that when the interrupt frequency count changes to “3”, the signal state value State becomes “2” and an absolute value of the difference value Theta_diff_low between the angle estimation value Theta_est (value of the point P3) and the angle current value Theta_edge_now becomes larger than the threshold Dth. In this case, the arithmetic device 15 changes only an output mode of the B-phase pulse signal PB to the low-level output mode based on the signal state value State. As a result, as illustrated in FIG. 9, at a timing at which the interrupt frequency count changes to “3”, only the B-phase pulse signal PB output from the second timer 13 changes to a low level.

As illustrated in FIG. 9, it is assumed that when the interrupt frequency count changes to “5”, the signal state value State becomes “1” and an absolute value of the difference value Theta_diff_low between the angle estimation value Theta_est (value of the point P5) and the angle current value Theta_edge_now becomes larger than the threshold Dth. In this case, the arithmetic device 15 changes only an output mode of the A-phase pulse signal PA to the high-level output mode based on the signal state value State. As a result, as illustrated in FIG. 9, at a timing when the interrupt frequency count changes to “5”, only the A-phase pulse signal PA output from the second timer 13 changes to a high level.

As illustrated in FIG. 9, it is assumed that when the interrupt frequency count changes to “7”, the signal state value State becomes “0” and an absolute value of the difference value Theta_diff_low between the angle estimation value Theta_est (value of the point P7) and the angle current value Theta_edge_now becomes larger than the threshold Dth. In this case, the arithmetic device 15 changes only an output mode of the B-phase pulse signal PB to the high-level output mode based on the signal state value State. As a result, as illustrated in FIG. 9, at a timing when the interrupt frequency count changes to “7”, only the B-phase pulse signal PB output from the second timer 13 changes to a high level.

When the A-phase pulse signal PA and the B-phase pulse signal PB are output from the second timer 13 by the interrupt processing as described above, as illustrated in FIG. 10, the third timer 14 counts the number of edges of the A-phase pulse signal PA and the B-phase pulse signal PB, and resets the edge count value EC when the edge count value EC reaches the timer reset value TRES3. Further, as illustrated in FIG. 10, the third timer 14 compares the edge count value EC with the Z-phase output threshold Zcom, and outputs, as the Z-phase pulse signal PZ, a signal that becomes a high level when the edge count value EC is smaller than the Z-phase output threshold Zcom. In FIG. 10, ENCᵣₑₛ indicates resolution. The timer reset value TRES3 is set to a value of “ENCᵣₑₛ₋₁”.

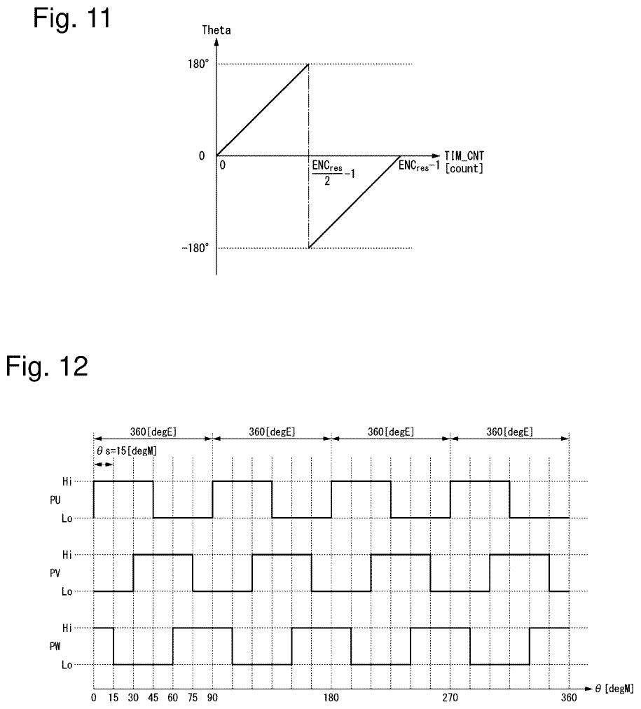

Since an edge count value of the third timer 14 is “0” when the processing device 10 is switched to a power-on state, it is necessary to set an initial value of an edge count value in accordance with a mechanical angle so as to achieve a relationship illustrated in FIG. 11. In view of the above, in the present embodiment, when the processing device 10 is switched to the power-on state, the arithmetic device 15 performs processing of setting an initial value of the edge count value EC based on Expressions (14) and (15) below as one piece of initialization processing. Note that, in Expressions (14) and (15) below, TIM_CNT represents an initial value of an edge count value. Further, in the present description, (uint32) (X) represents casting X to unsigned 32 bits, and Y>>Z represents shifting Y to the right by Z bits.

$$\begin{matrix}[ Mathematical formula 2 ] & \\ \begin{matrix}When Theta \geq 0 \\ TIM\_CNT = ( uint 32 ) ( ( ( Theta >> 16 ) \times {ENC}_{r e s} ) >> 16 )\end{matrix} & ( 14 )\end{matrix}$$

$$\begin{matrix}[ Mathematical formula 3 ] & \\ \begin{matrix}When Theta < 0 \\ TIM\_CNT = ( uint 32 ) ( E N {C}_{res} - ( ( ( ( - 1 ) * Theta ) >> 16 ) \times {ENC}_{r e s} ) >> 16 )\end{matrix} & ( 15 )\end{matrix}$$

The A-phase pulse signal PA, the B-phase pulse signal PB, and the Z-phase pulse signal PZ are output from the processing device 10 by the above-described online processing (angle calculation processing and interrupt processing) being executed by the arithmetic device 15. Similarly to a general incremental encoder, also in the angle detection device 1 of the present embodiment, the A-phase pulse signal PA and the B-phase pulse signal PB start to be output quickly after the power of the processing device 10 is turned on, but the Z-phase pulse signal PZ may be output later.

Hereinafter, with reference to FIG. 12, signal generation processing executed as one piece of the online processing by the arithmetic device 15 in the first example in order to generate the three-phase pulse signals PU, PV, and PW having a phase difference of 120 degrees in terms of electrical angle will be described.

FIG. 12 is a timing chart illustrating an example of the three-phase pulse signals PU, PV, and PW generated by the arithmetic device 15 of the processing device 10. In FIG. 12, the horizontal axis represents a calculated value of the mechanical angle θ. Here, the calculated value of the mechanical angle θ is a value of θ(count) calculated every time the interrupt processing is executed, that is, the angle estimation value Theta_est.

As illustrated in FIG. 12, when the calculated value of the mechanical angle θ matches with the mechanical angle of zero degrees at the time of executing the signal generation processing, the arithmetic device 15 switches a level of a pulse signal of any one phase of the three-phase pulse signals PU, PV, and PW. As an example, the arithmetic device 15 switches a level of the U-phase pulse signal PU to a high level when the calculated value of the mechanical angle θ matches with the mechanical angle of zero degrees. The arithmetic device 15 switches a level of the U-phase pulse signal PU to a high level, and simultaneously sets the V-phase pulse signal PV to a low level and sets the W-phase pulse signal PW to a high level.

The arithmetic device 15 calculates an angle θs based on Equation (16) below including the number P of pole pairs of the rotor magnet, and switches a level of a pulse signal of any one phase of the three-phase pulse signals PU, PV, and PW every time the calculated value of the mechanical angle θ changes by the angle θs. In the present embodiment, since N is 3 and P is 4, the angle θs is 15 degrees (15 [degM]) in mechanical angle.

$$Θ s [ d e g M ] = 3 \; 60 [ deg E ] / 2 \cdot N \cdot P \qquad ( 16 )$$

For example, as illustrated in FIG. 12, the arithmetic device 15 switches a level of the W-phase pulse signal PW to a low level when the calculated value of the mechanical angle θ changes from 0 [degM] to 15 [degM]. When the calculated value of the mechanical angle θ changes from 15 [degM] to 30 [degM], the arithmetic device 15 switches a level of the V-phase pulse signal PV to a high level. When the calculated value of the mechanical angle θ changes from 30 [degM] to 45 [degM], the arithmetic device 15 switches a level of the U-phase pulse signal PU to a low level.

When the calculated value of the mechanical angle θ changes from 45 [degM] to 60 [degM], the arithmetic device 15 switches a level of the W-phase pulse signal PW to a high level. When the calculated value of the mechanical angle θ changes from 60 [degM] to 75 [degM], the arithmetic device 15 switches a level of the V-phase pulse signal PV to a low level. When the calculated value of the mechanical angle θ changes from 75 [degM] to 90 [degM], the arithmetic device 15 switches a level of the U-phase pulse signal PU to a high level.

The arithmetic device 15 generates the three-phase pulse signals PU, PV, and PW for one mechanical angle cycle by performing the above level switching processing performed in a range of 0 [degM] to 90 [degM] in each of a range of 90 [degM] to 180 [degM], a range of 180 [degM] to 270 [degM], and a range of 270 [degM] to 360 [degM]. As illustrated in FIG. 12, one electrical angle cycle (360 [degE]) of the three-phase pulse signals PU, PV, and PW corresponds to 90 degrees (90 [degM]) in mechanical angle. Further, the three-phase pulse signals PU, PV, and PW have a phase difference of 30 degrees in mechanical angle, that is, 120 degrees in electrical angle.

As described above, the offline processing illustrated in FIG. 4 is executed by the arithmetic device 15, so that the storage device 20 stores the mechanical angle of zero degrees (angle reset value θres[0]) corresponding to a rotational position (origin) where the rotor magnet is fixed by the d-axis current conduction as the level switching angle. Then, when executing the signal generation processing as one piece of the online processing, the arithmetic device 15 switches a level of the U-phase pulse signal PU to a high level when the calculated value of the mechanical angle θ matches with the mechanical angle of zero degrees.

For this reason, even if deviation occurs between a zero-cross position of the sensor magnet 40 and a zero-cross position of the rotor magnet due to an attachment error or the like generated when the sensor magnet 40 is attached to the rotor shaft 110, a timing at which a level of the U-phase pulse signal PU is switched at least at the origin can be substantially matched with an ideal timing. As a result, during a period until the Z-phase pulse signal PZ is output from the processing device 10 after the power of the processing device 10 is turned on, a rotational position of the rotor magnet (rotational position of the rotor shaft 110) can be indicated with high accuracy by the three-phase pulse signals PU, PV, and PW output from the processing device 10.

Note that, in the above embodiment, the first example in which only the mechanical angle of zero degrees corresponding to a rotational position (the origin) where the rotor magnet is fixed is stored as the level switching angle in the storage device 20, and another level switching angle is acquired by calculation. In the first example, there is a possibility that a timing at which a level of the three-phase pulse signals PU, PV, and PW is switched at a level switching angle other than the origin (mechanical angle of zero degrees) deviates from an ideal timing. However, the first example is effective in that the three-phase pulse signals PU, PV, and PW can be obtained by relatively simple processing.

Hereinafter, a second example in which a timing at which a level of the three-phase pulse signals PU, PV, and PW is switched can be substantially matched with an ideal timing even at a level switching angle other than the origin (mechanical angle of zero degrees) will be described.

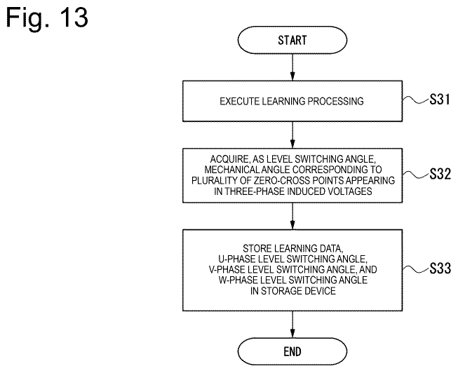

FIG. 13 is a flowchart illustrating offline processing executed by the arithmetic device 15 in the second example. As illustrated in FIG. 13, the arithmetic device 15 executes the learning processing to acquire, as learning data, a correspondence relationship between a pole pair number, a section number, and a segment number, feature data of each section, a mechanical angle arithmetic expression (the normalization coefficient k[i] and the angle reset value θres[i]) of each segment, and the like (Step S31). In the second example, it is not necessary to perform the d-axis current conduction to the three-phase motor 100 before executing the learning process as in the first example.

Subsequently, in a state where the rotor shaft 110 is rotated, the arithmetic device 15 acquires, as a level switching angle, the mechanical angle θ corresponding to a plurality of zero-cross points appearing in three-phase induced voltages Vu, Vv, and Vw of the three-phase motor 100 in cooperation with an external learning device (Step S32). The three-phase induced voltages Vu, Vv, and Vw include the U-phase induced voltage Vu appearing at a U-phase terminal of the three-phase motor 100, a V-phase induced voltage Vv appearing at a V-phase terminal of the three-phase motor 100, and a W-phase induced voltage Vw appearing at a W-phase terminal of the three-phase motor 100.

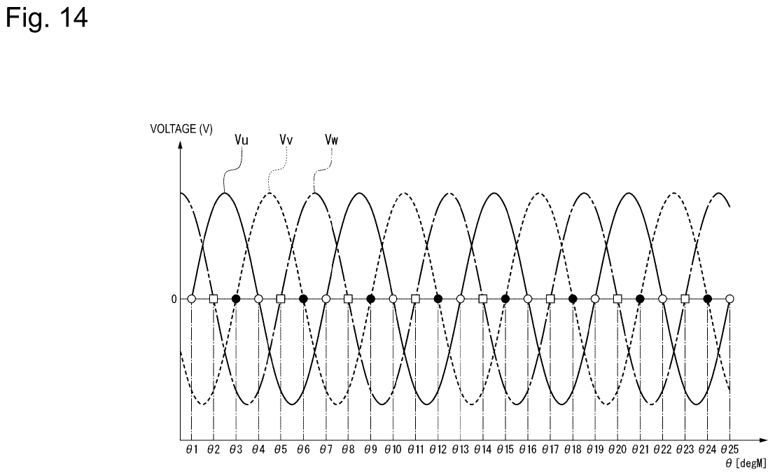

The learning device is a device that measures the three-phase induced voltages Vu, Vv, and Vw of the three-phase motor 100 in a state where the rotor shaft 110 is rotated, and transmits the measurement result to the processing device 10 (arithmetic device 15). FIG. 14 is a diagram illustrating an example of a waveform of the three-phase induced voltages Vu, Vv, and Vw. FIG. 14 illustrates a waveform of the three-phase induced voltages Vu, Vv, and Vw appearing at a terminal of each phase of the three-phase motor 100 in one mechanical angle cycle. The three-phase induced voltages Vu, Vv, and Vw have a phase difference of 120 degrees in electrical angle.

In FIG. 14, a white circle marker indicates a U-phase zero-cross point which is a zero-cross point at which the U-phase induced voltage Vu intersects reference potential (0 V). A black circle marker indicates a V-phase zero-cross point which is a zero-cross point at which the V-phase induced voltage Vv intersects the reference potential. A square marker indicates a W-phase zero-cross point which is a zero-cross point at which the W-phase induced voltage Vw intersects the reference potential.

Upon receiving a measurement result of the three-phase induced voltages Vu, Vv, and Vw from the learning device, the arithmetic device 15 executes the angle calculation processing and the interrupt processing included in the above-described online processing to acquire the mechanical angle θ corresponding to each of the U-phase zero-cross point, the V-phase zero-cross point, and the W-phase zero-cross point as the level switching angle. Here, the mechanical angle θ is a value of θ(count) calculated every time the interrupt processing is executed, that is, the angle estimation value Theta_est.

In FIG. 14, θ1, θ4, θ7, θ1θ, θ13, θ16, θ19, θ22, and 025 are the mechanical angles θ corresponding to the U-phase zero-cross point. Hereinafter, the mechanical angle θ corresponding to the U-phase zero-cross point is referred to as a U-phase level switching angle. θ3, θ6, θ9, θ12, θ15, θ18, θ21, and θ24 are the mechanical angles θ corresponding to the V-phase zero-cross point.

Hereinafter, the mechanical angle θ corresponding to the V-phase zero-cross point is referred to as a V-phase level switching angle. θ2, θ5, θ8, θ11, θ14, θ17, θ2θ, and θ23 are the mechanical angles θ corresponding to the W-phase zero-cross point. Hereinafter, the mechanical angle θ corresponding to the W-phase zero-cross point is referred to as a W-phase level switching angle.

Then, the arithmetic device 15 stores the learning data acquired in Step S31 and the U-phase level switching angle, the V-phase level switching angle, and the W-phase level switching angle acquired in Step S32 in the storage device 20 (Step S33).

As the offline processing described above is executed by the arithmetic device 15, the storage device 20 stores a relational expression (mechanical angle arithmetic expression) representing a relationship between output values (digital values of the three-phase sensor signals Hu, Hv, and Hw) of three of the magnetic sensors 31, 32, and 33 and the mechanical angle θ of the rotor shaft 110 and the mechanical angle θ corresponding to at least one rotational position of the rotor magnet as the level switching angle. More specifically, the storage device 20 stores, as the level switching angle, the mechanical angles θ corresponding to a plurality of zero-cross points appearing in the three-phase induced voltages Vu, Vv, and Vw of the three-phase motor 100.

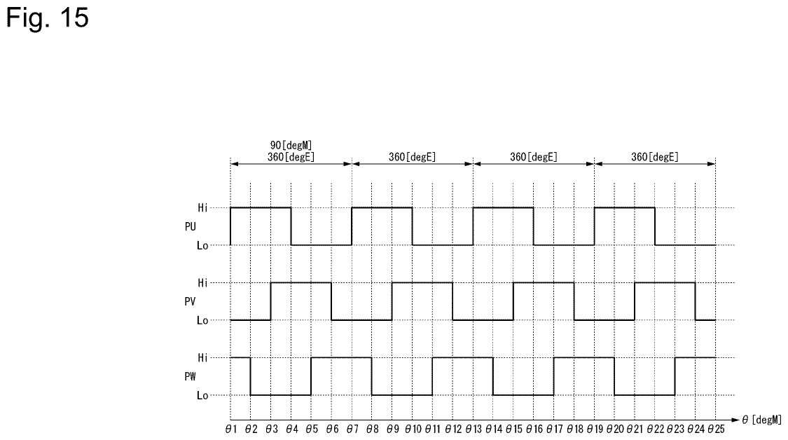

Hereinafter, with reference to FIG. 15, the signal generation processing executed as one piece of the online processing by the arithmetic device 15 in the second example in order to generate the three-phase pulse signals PU, PV, and PW having a phase difference of 120 degrees in terms of electrical angle will be described.

FIG. 15 is a timing chart illustrating an example of the three-phase pulse signals PU, PV, and PW generated by the arithmetic device 15 in the second example. In FIG. 15, the horizontal axis represents a calculated value of the mechanical angle θ. Here, the calculated value of the mechanical angle θ is a value of θ(count) calculated every time the interrupt processing is executed, that is, the angle estimation value Theta_est.

As illustrated in FIG. 15, when the calculated value of the mechanical angle θ matches with the level switching angle corresponding to a plurality of zero-cross points at the time of executing the signal generation processing, the arithmetic device 15 switches a level of a pulse signal of any one phase of the three-phase pulse signals PU, PV, and PW. As an example, the arithmetic device 15 switches a level of the U-phase pulse signal PU to a high level when the calculated value of the mechanical angle θ matches with the U-phase level switching angle θ1. The arithmetic device 15 switches a level of the U-phase pulse signal PU to a high level, and simultaneously sets the V-phase pulse signal PV to a low level and sets the W-phase pulse signal PW to a high level.

When the calculated value of the mechanical angle θ matches with the W-phase level switching angle θ2, the arithmetic device 15 switches a level of the W-phase pulse signal PW to a low level. When the calculated value of the mechanical angle θ matches with the V-phase level switching angle θ3, the arithmetic device 15 switches a level of the V-phase pulse signal PW to a high level. When the calculated value of the mechanical angle θ matches with the U-phase level switching angle θ4, the arithmetic device 15 switches a level of the U-phase pulse signal PU to a low level.

When the calculated value of the mechanical angle θ matches with the W-phase level switching angle θ5, the arithmetic device 15 switches a level of the W-phase pulse signal PW to a high level. When the calculated value of the mechanical angle θ matches with the V-phase level switching angle θ6, the arithmetic device 15 switches a level of the V-phase pulse signal PW to a low level. When the calculated value of the mechanical angle θ matches with the U-phase level switching angle θ7, the arithmetic device 15 switches a level of the U-phase pulse signal PU to a high level.

The arithmetic device 15 generates the three-phase pulse signals PU, PV, and PW for one mechanical angle cycle by performing the above level switching processing performed in a range from the U-phase level switching angle θ1 to the U-phase level switching angle θ7 in each of a range from the U-phase level switching angle θ7 to the U-phase level switching angle θ13, a range from the U-phase level switching angle θ13 to the U-phase level switching angle θ19, and a range from the U-phase level switching angle θ19 to the U-phase level switching angle θ25. As illustrated in FIG. 15, one electrical angle cycle (360 [degE]) of the three-phase pulse signals PU, PV, and PW corresponds to 90 degrees (90 [degM]) in mechanical angle. Further, the three-phase pulse signals PU, PV, and PW have a phase difference of 120 degrees in electrical angle.

In the second example, the offline processing illustrated in FIG. 13 is executed by the arithmetic device 15, so that the storage device 20 stores the mechanical angle θ corresponding to a plurality of zero-cross points appearing in the three-phase induced voltages Vu, Vv, and Vw of the three-phase motor 100 as the level switching angle. Then, when executing the signal generation processing as one piece of the online processing, the arithmetic device 15 switches a level of a pulse signal of any one phase of the three-phase pulse signals PU, PV, and PW when the calculated value of the mechanical angle θ matches with the level switching angle corresponding to a plurality of zero-cross points.

For this reason, even if deviation occurs between a zero-cross position of the sensor magnet 40 and a zero-cross position of the rotor magnet due to an attachment error or the like generated when the sensor magnet 40 is attached to the rotor shaft 110, a timing at which a level of the three-phase pulse signals PU, PV, and PW is switched at all zero-cross points of the three-phase induced voltages Vu, Vv, and Vw can be substantially matched with an ideal timing. As a result, in the second example, as compared with the first example, a rotational position of the rotor magnet (rotational position of the rotor shaft 110) can be indicated with higher accuracy by the three-phase pulse signals PU, PV, and PW output from the processing device 10 in a period until the Z-phase pulse signal PZ is output from the processing device 10 after the power of the processing device 10 is turned on.

As described above, according to the present embodiment, it is possible to provide the angle detection device 1 in an incremental system having a function of outputting not only the A-phase pulse signal PA, the B-phase pulse signal PB, and the Z-phase pulse signal PZ but also the U-phase pulse signal PU, the V-phase pulse signal PV, and the W-phase pulse signal PW based on the mechanical angle θ obtained by the position estimation method of Patent Literature 1.

Further, according to the angle detection device 1 of the present embodiment, since a timing at which a level of the three-phase pulse signals PU, PV, and PW is switched can be substantially matched with an ideal timing, a rotational position of the rotor magnet (a rotational position of the rotor shaft 110) can be indicated with high accuracy by the three-phase pulse signals PU, PV, and PW output from the processing device 10. That is, according to the present embodiment, it is possible to provide the angle detection device 1 capable of outputting the three-phase pulse signals PU, PV, and PW indicating a rotational position of the rotor magnet (rotational position of the rotor shaft 110) with high accuracy.

### VARIATION

The present invention is not limited to the above embodiment, and the configurations described in the present description can be appropriately combined within a range not conflicting with one another.

For example, in the embodiment described above, an aspect in which the first magnetic sensor 31, the second magnetic sensor 32, and the third magnetic sensor 33 are arranged in a state of facing the sensor magnet 40 having a disc shape in an axial direction of the rotor shaft 110 is exemplified, but the present invention is not limited to this aspect. For example, in a case where a ring-shaped magnet is used instead of the sensor magnet 40 having a disc shape, a magnetic flux flows in a radial direction of the ring-shaped magnet, and thus, the first magnetic sensor 31, the second magnetic sensor 32, and the third magnetic sensor 33 may be arranged in a state of facing the ring-shaped magnet in the radial direction of the ring-shaped magnet.

In the above embodiment, the case where the sensor group 30 includes three of the magnetic sensors 31, 32, and 33 is exemplified, but the number of magnetic sensors is not limited to three and only needs to be N (N is a multiple of three or more). Further, in the above embodiment, the case where the sensor magnet 40 and the rotor magnet have four magnetic pole pairs is exemplified, but the number of pole pairs of the sensor magnet 40 and the rotor magnet is not limited to four.

1. An angle detection device comprising:
a sensor magnet mounted on a rotation shaft of an N-phase motor (N is an integer of three or more) having a rotor magnet;
M (M is an integer of three or more) magnetic sensors that detect a magnetic flux change due to rotation of the sensor magnet;
a storage device that stores a relational expression representing a relationship between an output value of the M magnetic sensors and a mechanical angle of the rotation shaft, and the mechanical angle corresponding to at least one rotational position of the rotor magnet as a level switching angle; and
a processing device that calculates the mechanical angle based on the output value and the relational expression, and outputs an N-phase pulse signal having a phase difference of 360 degrees divided by N in terms of electrical angle based on a calculated value of the mechanical angle and the level switching angle,
wherein the processing device switches a level of a pulse signal of any one phase of the N-phase pulse signal when a calculated value of the mechanical angle matches with the level switching angle.

2. The angle detection device according to claim 1, wherein
the storage device stores, as the level switching angle, a mechanical angle of zero degrees corresponding to a rotational position where the rotor magnet is fixed by causing predetermined current to flow from a stator coil of one phase to a stator coil of a remaining phase among stator coils of N phases of the N-phase motor, and
the processing device switches a level of a pulse signal of any one phase of the N-phase pulse signal when a calculated value of the mechanical angle matches with the mechanical angle of zero degrees.

3. The angle detection device according to claim 2, wherein the processing device calculates an angle θs based on Equation (16) below including a number P of pole pairs of the rotor magnet, and switches a level of a pulse signal of any one phase of the N-phase pulse signal every time a calculated value of the mechanical angle changes by the angle θs:
$$Θ s [ d e g M ] = 3 \; 60 [ deg E ] / 2 \cdot N \cdot P \qquad ( 16 )$$

4. The angle detection device according to claim 1, wherein
the storage device stores, as the level switching angle, the mechanical angle corresponding to a plurality of zero-cross points appearing in N-phase induced voltage of the N-phase motor, and
the processing device switches a level of a pulse signal of any one phase of the N-phase pulse signal when a calculated value of the mechanical angle matches with the level switching angle corresponding to the plurality of zero-cross points.

5. An angle detection method of using a sensor magnet mounted on a rotation shaft of an N-phase motor (N is an integer of three or more) having a rotor magnet and M (M is an integer of three or more) magnetic sensors that detect a magnetic flux change due to rotation of the sensor magnet to detect a mechanical angle of the rotation shaft, the angle detection method comprising:
a first step of storing a relational expression representing a relationship between an output value of the M magnetic sensors and a mechanical angle of the rotation shaft, and the mechanical angle corresponding to at least one rotational position of the rotor magnet as a level switching angle; and
a second step of calculating the mechanical angle based on the output value and the relational expression, and outputting an N-phase pulse signal having a phase difference of 360 degrees divided by N in terms of electrical angle based on a calculated value of the mechanical angle and the level switching angle,
wherein in the second step, a level of a pulse signal of any one phase of the N-phase pulse signal is switched when a calculated value of the mechanical angle matches with the level switching angle.

6. The angle detection method according to claim 5, wherein
in the first step, a mechanical angle of zero degrees corresponding to a rotational position where the rotor magnet is fixed is stored as the level switching angle by causing predetermined current to flow from a stator coil of one phase to a stator coil of a remaining phase among stator coils of N phases of the N-phase motor, and
in the second step, a level of a pulse signal of any one phase of the N-phase pulse signal is switched when a calculated value of the mechanical angle matches with the mechanical angle of zero degrees.

7. The angle detection method according to claim 6, wherein in the second step, an angle θs is calculated based on Equation (16) below including a number P of pole pairs of the rotor magnet, and a level of a pulse signal of any one phase of the N-phase pulse signal is switched every time a calculated value of the mechanical angle changes by the angle θs:
$$θ s [ d e g M ] = 3 \; 60 [ deg E ] / 2 \cdot N \cdot P \qquad ( 16 )$$

8. The angle detection method according to claim 5, wherein
in the first step, the mechanical angle corresponding to a plurality of zero-cross points appearing in N-phase induced voltage of the N-phase motor is stored as the level switching angle, and
in the second step, a level of a pulse signal of any one phase of the N-phase pulse signal is switched when a calculated value of the mechanical angle matches with the level switching angle corresponding to the plurality of zero-cross points.
